(19) United States
(12) Patent Application Publication
(10) Pub. No.: US 2005/0105811 A1
(43) Pub. Date: May 19, 2005

(54) Processing images

(75) Inventor: Lambertus Antonius Van Eggelen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/504,747

(22) PCT Filed: Jan. 30, 2003
(86) PCT No.: PCT/IB03/00329

(30) Foreign Application Priority Data
Feb. 22, 2002 (EP) 02075725.8

(51) Int. Cl. G06T 9/00; H04N 7/12

(52) U.S. Cl. 382/239; 382/250; 375/240.2; 375/240.24; 375/240.26; 375/240.02

(57) ABSTRACT

A method for pre-processing an image format having black borders more efficiently. This method enables digital recorders to record such a format, in particular a so-called letterbox format used in broadcasts more efficiently.

### FIELD OF THE INVENTION

The present invention relates to a method for processing an image comprising relevant and irrelevant data. The invention is also related to corresponding apparatus.

### BACKGROUND OF THE INVENTION

Images can comprise user-relevant information such as video content of the images and user-irrelevant information such as borders, which are usually black.

For instance, in the current transition from 4:3 to 16:9 displays in television, many broadcasts transmit a display format called “the letterbox format”. In this format, black borders are added at the top and the bottom of a picture to be displayed. This enables a user of a 4:3 display, typically in a TV set, to view a 16:9 format as an image with video content and black borders, while a current TV set comprising a 16:9 display zooms the letterbox transmission in such a way that only the video content is displayed. A recorder, typically a digital recorder, that records the transmitted letterbox format on a receiver side therefore has to record a bit stream comprising both the video content and the black borders.

Currently, images are often encoded and compressed by means of methods such as block transform coding, which exploit the correlation between contiguous pixels within an image. This is typical for instance in methods based on MPEG, which will be further described in the detailed description of the invention.

In a block layer, the blocks are typically represented by quantized transform coefficients that can have some entries that are zero. However, for instance due to noise in analogue transmission from cable provider to customer, the top and bottom black borders are not completely black, but will also contain noise. As a result, not all the quantized transform coefficients are zero, which thereby will prevent an encoder to skip the blocks inside the top and bottom black border.

A further drawback, typical when compressing the letterbox format with MPEG or other block based encoding and compression, is that the black borders are not aligned on block boundaries. As a result, a very sharp transition from video content to black is present inside a block. After processing this block with a transform, it is likely that this block will have very few zero transform coefficients after quantization that can be efficiently encoded. Consequently, it will take a lot of bits to store the block with quantized transform coefficients. This drawback is also typical for other block based encoding methods, in which sharp transitions between contiguous pixels require a large number of bits because of the. non-zero transform coefficients.

### SUMMARY OF THE INVENTION

It is an object of the invention to provide a method for encoding images comprising relevant and irrelevant information by which the encoding efficiency is improved. To this end, the invention provides a method and an apparatus as defined in the independent claims. Advantageous embodiments are defined in the dependent claims.

According to a first aspect of the present invention a border or borders are re-generated on original boundaries.

According to a preferred embodiment of the invention, there is provided a method for processing an image comprising segments of pixels covering the image, said image comprising an area of relevant data and area(s) of irrelevant data, which area(s) of irrelevant data is/are outside the area of relevant information, said method comprising the step of:
re-generating the area(s) of irrelevant information.

Herein, the term “segment” means an area comprising at least one pixel, typically more. The segment can be in the form of a block, but also other forms such as circular etc are possible. In practical embodiments, square or rectangular blocks may be used.

Preferably, all pixels of the areas of irrelevant information are reset to a common pixel value. The term “common” means that all pixels within the same area of irrelevant information are set to the same value. This value can be zero or any other suitable value that can be encoded efficiently. Preferably, the areas of irrelevant information are re-blacked.

Typically, black borders are re-generated on the original boundaries of a letterbox. Other types of formats than the “letterbox format” having areas of relevant information and areas of irrelevant information can of course also be improved by means of the invention. Since the re-generated borders are black, all transform coefficients, for instance DCT coefficients will be zero and consequently they can be coded more efficiently.

This method enables for instance digital recorders to record such a format, in particular a so-called letterbox format used in broadcasts more efficiently.

Preferably, the areas of irrelevant information are aligned to segment borders and re-generated, preferably by making partially filled segments black. The term “partially filled” means that a segment comprises at least one pixel that is black. Thus, partially filled also includes half-filled segments, or nearly almost completely filled segments.

In a second aspect of some preferred embodiments of the invention, the black borders are re-generated on different block boundaries.

In a third aspect of some preferred embodiments of the invention, pixels, typically video lines, can be dropped to align borders.

According to another preferred embodiment of the invention, the areas of irrelevant information, i. e. the borders, are aligned on macro block boundaries. An advantage is that the MPEG standard provides a way to skip these empty macro blocks inside the upper and bottom black border.

According to another preferred embodiment of the invention, the borders are aligned on a block boundary, preferably of a block into a block level having a next higher level comprising macro blocks.

In a fourth aspect of some preferred embodiments of the invention, in which the black border are aligned on a block instead of a macro-block, it can be preferred to mirror chrominance information inside a block to achieve to optimum coding efficiency when using the video 4:2:0 format.

In a fifth aspect of some embodiments of the invention, by shifting the video content of the image, maximal 7 lines need to be removed for aligning it to a DCT block. Preferably, according to yet another aspect of the invention, the same amount of lines is dropped at top and bottom, for instance 4 at the top and 3 at the bottom.

According to another preferred embodiment of the invention, there is provided an apparatus for processing an image comprising segments of pixels covering the image, said image comprising an area of relevant data and area(s) of irrelevant data, which area(s) of irrelevant data is/are outside the area of relevant information, said apparatus comprising:
means for re-generating the areas of irrelevant information.

Preferably, the apparatus further comprises means for providing the areas of irrelevant information empty.

Preferably, the apparatus is connectable to a letterbox detector, which controls the apparatus to start pre-processing if the detector detects a letterbox transmission in a to the detector and apparatus incoming signal Qin.

This and other aspects of the invention will be apparent from and elucidated with reference to the embodiments(s) described hereinafter.

### BRIEF DESCRIPTION OF THE DRAWINGS

The present invention will be more clearly understood from the following description of the preferred embodiments of the invention read in conjunction with the attached drawings, in which:

FIG. 1 illustrates how an image in the form of a video frame is provided with black borders at the top and bottom of the video content.

FIG. 2 illustrates a video frame that is divided into blocks, which are not aligned to a black border to describe an aspect of the invention.

FIG. 3a-c illustrate mirroring chrominance information inside a block to achieve optimum coding efficiency when using the video 4:2:0 format

FIG. 4 illustrates an apparatus according to a preferred embodiment of the invention connected before a MPEG encoder.

FIG. 5 illustrates an implementation of an apparatus according to a preferred embodiment of the invention with a modified MPEG encoder.

FIG. 6 illustrates matching a letterbox detector between a recorder/player and TV set.

### DETAILED DESCRIPTION OF THE INVENTION

The invention will now be described by preferred embodiments in conjunction with accompanying drawing figures; however starting with a brief description of block based encoding by means of describing MPEG structure, which is prior art.

A MPEG-2 video bit stream has a layered structure. Each layer comprises one or more sub-layers. For instance, a video sequence can be divided into multiple groups of pictures, so-called “GOP”:s, representing sets of video frames which are contiguous in display order. In a sub-layer thereof the frames can be split into 16×16 macro blocks, which can be further split into yet another sub-layer of blocks. A macro-block comprises four 8×8 luminance discrete cosine transform (DCT) blocks and a number of chrominance blocks that are dependent on the coded format. Some of the coding properties are specified per macro block and some of them are specified per 8×8 block. E. g. only one set of so-called “motion vectors” is specified per macro block.

Three types of frames are used in the MPEG processing: intra frames (I-frames), which are coded without any reference to other frames, predicted frames (P-frames), which are coded with reference to past I- or P-frames, and bi-directionally interpolated frames (B-frames), which are coded with references to both past and future frames.

MPEG-2 specifies that the I-frames are “intra” coded so that the entire picture is broken into the 8×8 blocks of pixels, which blocks are typically processed by DCT and quantized to a compressed set of coefficients that alone represent the original picture. The MPEG-2 specification also allows for the P-frames rather than encoding all of the blocks by DCT, that so-called “motion compensation” is used to exploit a temporal redundancy found in most video data The motion compensation works in the way that within a GOP, a temporal redundancy among the frames is reduced by applying prediction to obtain a difference signal, a so-called prediction error, which is further compressed using DCT to remove spatial correlation. Thereafter the resulting DCT coefficients are quantized.

FIG. 1 illustrates how an image 1, in this example one video frame from a set of frames, for instance from a GOP, can be provided with black borders at the top and the bottom of the image. The image 1 comprises an area 2 of relevant data and areas 3 of irrelevant data outside the area 2 of relevant information. In this figure, these areas 3 of irrelevant information are the black borders that are added in the letterbox format transmission. FIG. 1 also illustrates how such a transmission will appear on a 4:3 display. On a 16:9 display these black borders will be zoomed and consequently disappear for a user.

In FIG. 2, which illustrates an aspect of the invention, it is illustrated how an image 1, also in this case a video frame, of which only the black border at the bottom is illustrated, is divided into blocks. Herein, a method according to a preferred embodiment of the invention will be described based on the described MPEG structure; however, the invention is not in any sense limited to this particular coding. Any block based coding can be employed without departing from the idea of the invention. In this figure, two types of blocks are shown, 16×16 macro-blocks 4, of which one is shown, and 8×8 DCT blocks 5, of which four of shown. The 8×8 DCT blocks comprise a number of chrominance blocks, indicated by dashed lines, but are not further described.

According to a preferred embodiment of the invention, the areas of irrelevant information are re-generated on the original location, so that they can be coded efficiently without discarding original video content, while removing noise in the original black borders.

According to an aspect of the invention, the black borders at the top and bottom are re-generated on block boundaries 6. A block boundary 6 can be guaranteed by making the lines inside a half-filled block 7 black. Preferably, video lines can be dropped to align borders. The invention is not limited to video lines as in this particular example. Any pixel value outside a border of an image segmentation is within the scope of the invention.

Because the re-generated borders are black, all DCT coefficients will be zero and consequently the DCT blocks will be empty.

According to a preferred embodiment of the invention, the borders are aligned on macro block boundaries 6. Then, the MPEG standard provides a way to skip empty macro blocks inside the upper and bottom black border.

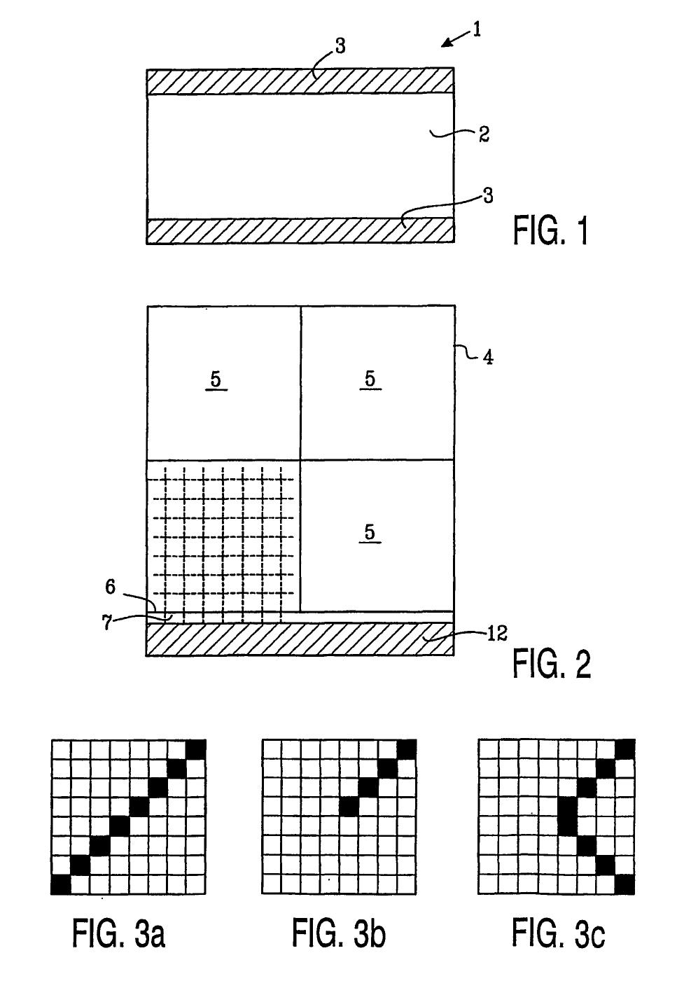

According to another preferred embodiment of the invention, in which the black border aligns on a block 5 instead of a macro-block 4, it can be preferred to mirror the chrominance information inside a block to achieve to optimum coding efficiency when using the video 4:2:0 format. This is illustrated in FIG. 3a-c.

FIG. 3a illustrates an 8×8 chrominance block 5 before DCT. FIG. 3b illustrates the same after re-creating the block border on luminance block boundary using the 4:2:0 formats. In FIG. 3c it is illustrated how the chrominance blocks are mirrored to achieve optimum performance.

According to another preferred embodiment of the invention, the borders are aligned on a DCT block grid instead of a macro block grid. In this case, MPEG is still capable to code the empty blocks efficiently.

Because the video lines inside a half-filled DCT block are removed, the number of removed lines should be minimised. According to another preferred embodiment of the invention, to achieve this, the video can be shifted a few lines up or down for alignment to the nearest block boundary. According to another embodiment of the invention, modifying a start-pointer to a frame in memory can do this.

By shifting the video content of the image, maximal 7 lines need to be removed for aligning it to a DCT block. Preferably, according to yet another embodiment of the invention, the same amount of lines is dropped at top and bottom, for instance 4 at the top and 3 at the bottom.

For aligning to a macro-block boundary, maximal 15 lines are removed, for instance 7 at the top and 8 at the bottom.

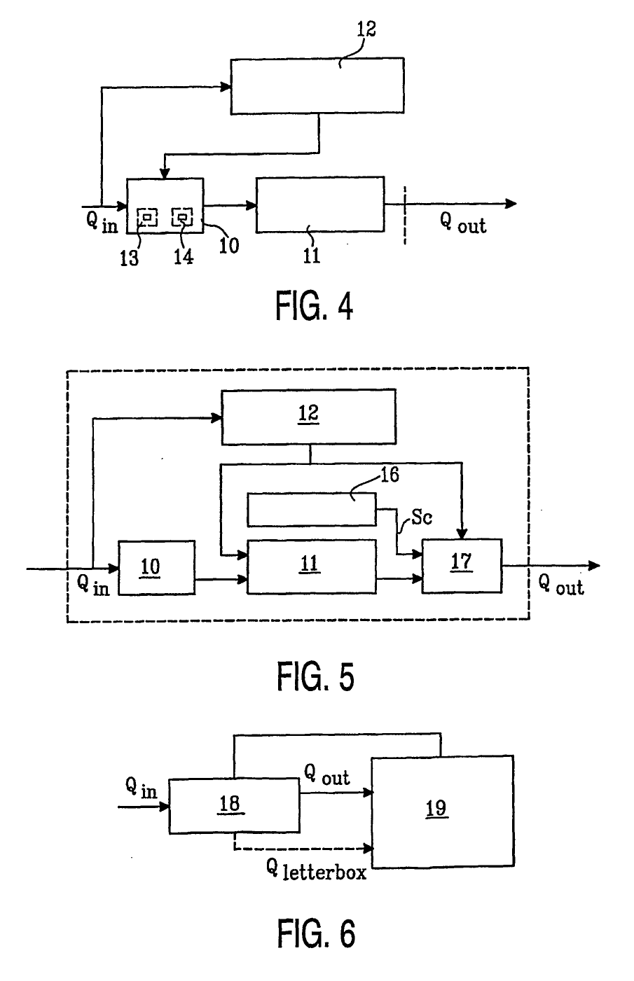

The method according to various embodiments of the invention can be implemented in several ways. Depending on the changes that can be tolerated on the MPEG encoder, it is also possible to lower the total required resources. FIG. 4 illustrates a preferred embodiment of an apparatus and its implementation with a MPEG encoder.

According to the preferred embodiment of the invention, illustrated in FIG. 4, an apparatus 10 for pre-processing a signal is connected before a MPEG encoder 11. A letterbox detector 12, which is well known within this technical field, is connectable to the apparatus 10. An incoming signal Qin is transmitted to the apparatus 10 for pre-processing and also to the letterbox detector 12. When using this implementation, the pre-processing will re-create the black borders and mirrors the chrominance information if necessary.

The apparatus 10 comprises means 13 for re-generating the areas of irrelevant information, and means 14 for providing the areas, typically all blocks, of irrelevant information empty, so that the can be coded efficiently. The means 14 can also be employed for aligning on block boundaries. The means 13 and 14 can also be combined

In FIG. 5 another implementation of the apparatus 10 is illustrated. The apparatus 10 is connected before a MPEG encoder 11. An incoming stream Qin is transmitted to the apparatus 10 for pre-processing and to a letterbox detector 12. The letterbox detector 12 is connected to the MPEG encoder 11 and to a stream concatenation unit 17. In this implementation, the MPEG encoder 11 is changed to be able to utilise the fill potential of the method according to the invention. As illustrated in this figure, it is possible to use a pre-defined MPEG stream Sc obtained by means 16 for providing constant black border streams. The means 16 for providing constant black border streams can comprise a memory circuit (not illustrated), for instance in a ROM for storing information about the stream. Of course any other suitable type of memory circuit can be employed such as other non-volatile semi-conductor memories or the like.

The stored and pre-defined stream Sc is used for the black borders that in the stream concatenation unit 17 can be added to the MPEG stream generated by the encoder 11 to an outgoing stream Qout.

If the letterbox detector 12 detects a letterbox format broadcast, the encoder 11 may skip the processing including motion estimation for the blocks/macro blocks inside the black borders while for those macro-blocks/blocks the pre-defined MPEG stream Sc is used instead. As a result, the hardware will require fewer resources while providing efficient encoding.

If the letterbox detector inside a recorder is matched with a letterbox detector in a TV set, mistakes of the letterbox detector (thinking it is an letterbox transmission, while it is an 4:3 broadcasting) inside the recorder can be masked by the TV set. In FIG. 6, it is illustrated an embodiment of the invention, wherein a recorder/player 18 receives an incoming signal Qin. The recorder/player 18 is connectable to a TV set 19 and sends a signal Qout. An optimum implementation would be to use the same letterbox detector inside the recorder/player 18 when playing a disc, while it sends a letterbox signal Qletterbox to the TV set 19. The signal Qletterbox is indicated by dots to illustrate a letterbox yes/no choice. Matching the letterbox detector is illustrated by a line M between recorder/player 18 and TV set.

If the recorder made a mistake and created black borders while is was a 4:3 broadcasting, the TV set 19 will zoom the transmission in such a way that the borders that were made black by the recorder are not visible. However, if the user has disabled the letterbox detector, the TV set will not mask the mistakes made in the recorder anymore.

Currently we are at the beginning phase of the transition from 4:3 to 16:9 displays. As some of the letterbox transmissions will display half of the sub-titles in the black borders, some of the advantages will disappear when the sub-titles are displayed in the black border. However, it is considered that at the end of the transition from 4:3 to 16:9 all broadcasters will prevent putting the sub-titles in the black borders as this cause numerous disadvantages on 16:9 displays. Of course this is only valid when sub-titles are used.

The invention can also be employed for instance in MPEG software, PC based format conversion tools and wide-screen DVD, since typically current wide-screen DVD:s are coded with black borders.

The advantages of the invention are several, for instance higher coding efficiency, less resources needed for encoding (of course depending on implementation) and no quantization artefacts at the starting point on the black borders.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for processing an image comprising segments of pixels covering the image, said image comprising an area of relevant data and area(s) of irrelevant data, which area(s) of irrelevant data is/are outside the area of relevant information, said method comprising the step of:
re-generating the area(s) of irrelevant information.

2. A method according to claim 1, wherein the areas of irrelevant information are borders, wherein all pixels of the areas of irrelevant information are re-set to a common pixel value.

3. A method according to claim 2, wherein the areas of irrelevant information are black borders that are re-blacked.

4. A method according to claim 1, wherein the areas of irrelevant information are aligned to segment borders and re-generated, preferably by making partially filled segments black.

5. A method according to claim 4, wherein the areas of irrelevant information are aligned to macro block boundaries.

6. A method according to claim 4, wherein the areas of irrelevant information are aligned to a block boundary of a block.

7. A method according to claim 6, wherein chrominance information inside the block is mirrored to achieve optimum coding efficiency in a 4:2:0 video format.

8. Apparatus for processing an image comprising segments of pixels covering the image (1), said image (1) comprising an area (2) of relevant data and area(s) of irrelevant data, which area(s) of irrelevant data is/are outside the area of relevant information, said apparatus (10) comprising:
means (13) for re-generating the areas (3) of irrelevant information.

9. Apparatus according to claim 8, further comprising:
means (14) for providing the areas (3) of irrelevant information empty.

10. Apparatus according to claim 8, wherein the apparatus (10) is connectable to a letterbox detector (12), which controls the apparatus (10) to start pre-processing if the detector (12) detects a letterbox transmission in an to the detector (12) and apparatus (10) incoming signal Qin.
